(19) United States
(12) Patent Application Publication
(10) Pub. No.: US 2015/0269032 A1
(43) Pub. Date: Sep. 24, 2015

(54) BACKING UP DATA TO CLOUD DATA STORAGE WHILE MAINTAINING STORAGE EFFICIENCY

(71) Applicant: NetApp, Inc., Sunnyvale, CA (US)

(72) Inventors: Kartheek Muthyala, Bangalore (IN); Ranjit Kumar, Bangalore (IN); Sisir Shekhar, Bangalore (IN)

(21) Appl. No.: 14/217,941

(22) Filed: Mar. 18, 2014

(51) Int. Cl. G06F 11/14; G06F 17/30

(52) U.S. Cl. CPC G06F 11/1464; G06F 17/30174; G06F 17/30076; G06F 17/30106; G06F 2201/84

(57) ABSTRACT

Technology is disclosed for backing up data to and recovering data from a destination storage system that stores data in a format different form that of a primary storage system (“the technology”). A replication stream having the data of multiple files, metadata of the files, and reference maps including a mapping of the corresponding file to a portion of the data of the corresponding file is generated at the primary storage system. The replication stream is sent to a parser to map or convert the data, the files, and the reference maps to multiple storage objects in a format the destination storage system is configured to store. Various types of storage objects are generated, including a first type of the storage objects having the data, a second type of storage objects storing the reference maps, and a third type of the storage objects storing metadata of the files.

### TECHNICAL FIELD

Several of the disclosed embodiments relate to data storage, and more particularly, to backing up and restoring data to and from a cloud data storage system that stores data in a format different from that of a primary storage system.

### BACKGROUND

A storage server operates on behalf of one or more clients to store and manage shared files. A client can request the storage server to backup data stored in a primary data storage system (“storage system”) of the data storage server (“storage server”) to one or more secondary storage systems. Many storage systems include applications that provide tools for administrators to perform scheduling and creation of database backups, and restoration of data from these backups in the event of data loss. Some traditional storage systems use secondary storage systems that typically use a same storage mechanism (e.g., a file system) as that of a primary storage system. However, such storage mechanisms do not provide a flexibility to use other heterogeneous secondary storage systems, e.g., third party storage services such as a cloud storage service, because these secondary storage systems often use a different storage mechanism from that of the primary storage system for storing the data.

Some traditional storage systems use heterogeneous secondary storage systems for backing up data. However, current techniques that allow backing up of data to heterogeneous secondary storage systems are inefficient. The current techniques do not provide optimal storage utilization at the secondary storage system; do not support deduplication; or consume significant computing resources, e.g., network bandwidth and processing time, in converting data from one format to the other for backing up and restoring data. Accordingly, traditional network storage systems do not allow the data to be backed up and recovered from heterogeneous storage systems efficiently.

### BRIEF DESCRIPTION OF THE DRAWINGS

FIG. 1 is a block diagram illustrating an environment in which data backup and recovery to and from a cloud storage service can be implemented.

FIG. 2 is a block diagram illustrating a networked storage system for backing up and restoring data to and from a cloud storage service, consistent with various embodiments of the disclosed technology.

FIG. 3 is a block diagram illustrating various inode configurations, consistent with various embodiments of the disclosed technology.

FIG. 4 is a block diagram illustrating a replication stream generated using logical replication engine with storage efficiency (LRSE) protocol, consistent with various embodiments of the disclosed technology.

FIG. 5 illustrates a block diagram for creating storage objects from a replication stream, consistent with various embodiments of the disclosed technology.

FIG. 6 is a block diagram illustrating backing up incremental point-in-time images to a destination storage system, consistent with various embodiments of the disclosed technology.

FIG. 7, which includes FIGS. 7A, 7B and 7C, is a block diagram illustrating recovering data from a destination storage system to restore a primary storage system to a particular point-in-time image, consistent with various embodiments of the disclosed technology.

FIG. 8 is a flow diagram of a process of backing up data to an object-based destination storage system using logical replication engine with storage efficiency (LRSE) protocol, consistent with various embodiments of the disclosed technology.

FIG. 9 is a flow diagram of a process for backing up incremental point-in-time images to an object-based destination storage system using LRSE protocol, consistent with various embodiments of the disclosed technology.

FIG. 10 is a flow diagram of a process for recovering data from an object-based destination storage system to restore a primary storage system to a particular point-in-time image, consistent with various embodiments of the disclosed technology.

FIG. 11 is a block diagram of a computer system as may be used to implement features of some embodiments of the disclosed technology.

### DETAILED DESCRIPTION

Technology is disclosed for backing up data to and restoring data from a storage service that stores data in a format different from that of a primary storage system (“the technology”). Various embodiments of the technology provide methods for mapping the data from a storage format of the primary storage system, e.g., block-based storage format, to a storage format of a destination storage system, e.g., an object-based storage format, while maintaining storage efficiency. In some embodiments, a replication stream is generated to back up a point-in-time image (“PTI”; sometimes referred to as a “snapshot”) of the primary storage system, e.g., a read-only copy of a file system of the primary storage system. The replication stream can have data of multiple files (e.g., as data stream), metadata of the files (e.g., as metadata stream), and a reference map (e.g., as reference stream) that identifies, e.g., for each of the files, a portion of the data belonging to the file. The replication stream is sent to a cloud data parking parser that backs up the PTI to the destination storage system. The cloud data parking parser identifies the data, metadata and the reference map from the replication stream and generates one or more storage objects in object-based format for each of the data, the metadata and the reference map. The one or more storage objects are then sent to the destination storage system, where they are stored in an object container.

In some embodiments, the primary storage system can be a block-based file storage system that manages data as blocks. An example of such a storage system includes Network File System (NFS) file servers provided by NetApp of Sunnyvale, Calif. In some embodiments, the block-based primary storage system organizes files using inodes. An inode is a data structure that has metadata of the file and locations of the data blocks (also referred to as “data extents”) that store the file data. The inode has associated inode identification (ID) that uniquely identifies the file. A data extent also has an associated data extent ID that uniquely identifies the data extent. Each of the data extents in the inode is identified using a file block number (FBN). The files are accessed by referring to the inodes of the files. The files can be stored in a multi-level hierarchy, e.g., in a directory within a directory.

In some embodiments, the destination storage system can be an object-based storage system, e.g., a cloud storage service. An example of such a cloud storage service includes S3 from Amazon of Seattle, Wash., Microsoft Azure from Microsoft of Redmond, Wash. In some embodiments, the object-based destination storage system can have a flat file system that stores the data objects in a same hierarchy. For example, the data objects are stored in an object container, and the object container may not store another object container in it. All the data objects for a particular object container can be stored in the object container in the same hierarchy.

To back up a PTI from the block-based storage system to the object-based storage system, a replication stream that includes (a) a data stream containing data extents (and their corresponding data extent IDs) representing data of the files at the primary storage system, (b) a reference stream having a reference map that having a mapping of the FBNs of the inode of a corresponding file to the data extents having the data of the corresponding file, and (c) a metadata stream that has metadata of the inode of the corresponding file is generated. The replication stream is then sent to the cloud data parking parser which generates one or more data storage objects that have the data extents, one or more reference map storage objects that have the reference maps, and one or more inode storage objects that have the metadata of the inodes. The data storage objects, reference map storage objects and the inode storage objects corresponding to the PTI of the primary storage system are sent to the destination storage system for storing.

Various embodiments of the technology provide methods for recovering data from the cloud storage service to restore the primary storage system. In some embodiments, the primary storage system can be restored to a particular PTI maintained at the destination storage system. The destination storage system can include multiple PTIs of the primary storage system which are generated sequentially over a period of time. A common PTI that is available on both the primary storage system and the destination storage system is identified. The primary storage system is then restored to the common PTI. A difference between the common PTI and the particular PTI is determined. In some embodiments, finding the difference can include identifying a state of the primary storage system, e.g., a set of files and the data of the set of files that correspond to the particular PTI, and identifying changes made to the state starting from the particular PTI up to the common PTI.

One or more replication jobs are generated for obtaining the difference from the destination storage system and applying the difference to the common PTI on the primary storage system to restore to the particular PTI. The jobs can include a deleting job for deleting the files and/or their corresponding data, e.g., inodes and/or data extents, from the common PTI which are added to the primary storage system after the particular PTI was generated. The jobs can include an inserting job for inserting the files and/or their corresponding data, e.g., inodes and/or data extents, to the common PTI which were deleted at the primary storage system after the particular PTI was generated. The jobs can include an updating job for updating the files, e.g., reference maps of the inodes, which were modified after the particular PTI was generated.

### Environment

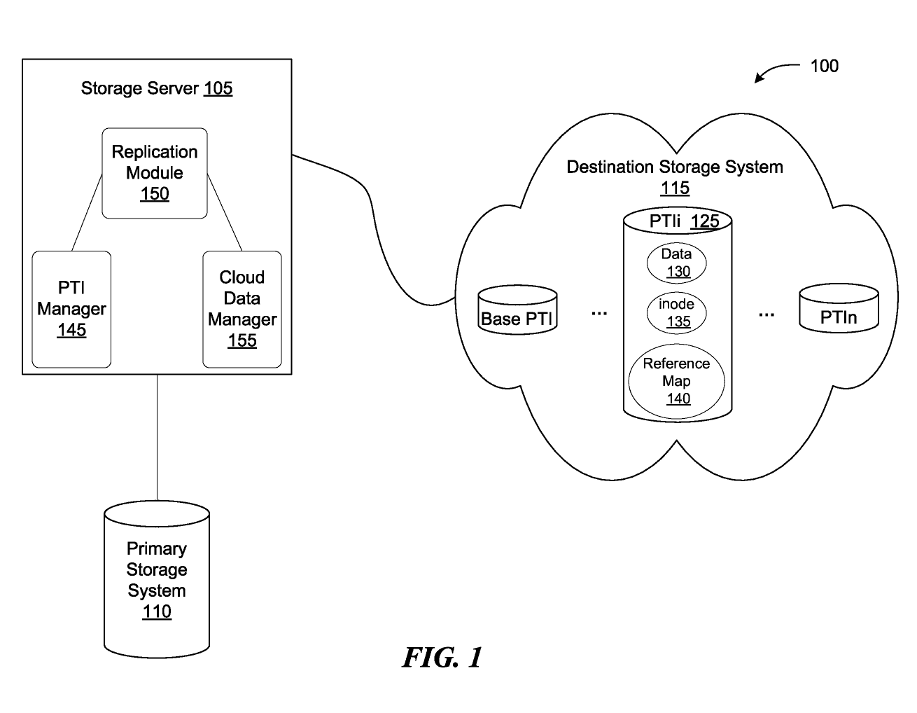

FIG. 1 is a block diagram illustrating an environment 100 in which data backup and recovery to and from a cloud storage service can be implemented. The environment 100 includes a storage server 105 that can back up data from a primary storage system 110 to a destination storage system 115. The storage server 105 can also recover data from the destination storage system 115 to restore the primary storage system 110. The primary storage system 105 can store data in a format different from that of the destination storage system 115.

In some embodiments, the primary storage system 110 can be a block-based storage system which manages data as blocks. An example of storage server 105 that stores data in such a format is Network File System (NFS) file servers commercialized by NetApp of Sunnyvale, Calif., that uses various storage operating systems, including the NetApp® Data ONTAP.™ However, any appropriate storage server can be enhanced for use in accordance with the embodiments of the technology described herein. A file system of the storage server describes the data stored in the primary storage system 110 using inodes. An inode is a data structure that has metadata of the file, and the file data or locations of the data extents that has the file data. The files are accessed by referring to the inodes of the files.

The storage server 105 can include a PTI manager component 145 that can generate a PTI of the file system of the storage server 105. A PTI is a read-only copy of an entire file system at a given instant when the PTI is created. The PTI includes the data stored in the primary storage system 110. In some embodiments, the PTI includes the data extents and metadata of the data, e.g., inodes to which the data extents belong, and metadata of the inodes. A newly created PTI refers to exactly the same data extents as an “active file system” (AFS) does. Therefore, it is created in a small period of time and does not consume any additional disk space. The AFS is a file system to which data can be both written and read, or, more generally, an active store that responds to both read and write operations. Only as data extents in the active file system are modified and written to new locations on the primary storage system 110 does the PTI begin to consume extra space. In some embodiments, the PTIs can be generated sequentially at regular intervals. Each of the sequential PTIs includes only the changes, e.g., additions, deletions or modifications to the files, from the previous PTI. A base PTI can be a PTI that has a full copy of the data, and not just the changes from the previous PTI, stored at the primary storage system 110. The PTIs can be backed up to the destination storage system 115.

In some embodiments, the destination storage system 115 can be an object-based storage system, e.g., a cloud data storage service (“cloud storage service”). Accordingly, the PTI data generated by the PTI manager 145 has to be converted to the storage objects.

A replication module 150 generates a replication stream to replicate the PTI to the destination storage system 115. The replication stream can include the data of multiple files, e.g., as data extents, metadata of the files, e.g., inodes, and a reference map that identifies for each of the files the data extents storing the data of the file. However, contents of the replication stream may not be stored as is in the destination storage system 115 because the contents are in a format that is different from what the destination storage system 115 expects. Accordingly, the contents of the replication stream may have to be converted or translated or mapped to a format, e.g., to storage objects that can be stored at the destination storage system 115. The replication stream is sent to a cloud data manager 155 that parses the content of the replication stream, generates the storage objects corresponding to the content, and backs up the storage objects for the PTI to the destination storage system 115. In some embodiments, the cloud data manager 155 can be implemented in a separate server, e.g., a server different from that of the storage server 105.

In some embodiments, parsing the replication stream includes extracting the data, the metadata of the files, and the reference map from the replication stream. After the extraction, the cloud data manager 155 generates one or more storage objects for the data (referred to as “data storage objects”), one or more storage objects for the metadata (referred to as “inode storage objects”), and one or more storage objects for the reference map (referred to as “reference map storage objects”). The one or more storage objects are then sent to the destination storage system 115.

In some embodiments, the object-based destination storage system 115 can have a flat file system that stores the storage objects in a same hierarchy. For example, all the storage objects of a particular PTI “SSi,” e.g., data storage objects 130, inode storage objects 135, and reference-map storage objects 140, are stored in an object container 125 in the same hierarchy. The object container 125 may not include another object container within. Further, the PTIs can be organized in the destination storage system in various ways. For example, every PTI can be stored in a corresponding object container. In another example, there can be one object container per volume of the primary storage system 110 for which the PTI is generated. All the PTIs generated for a particular volume may be stored in the object container corresponding to the particular volume.

Referring back to the cloud data manager 155, the cloud data manager 155 can be implemented within the storage server 105 or in one or more separate servers. The destination storage system 115 provides various application programming interfaces (APIs) for generating the storage objects in a format specific to the destination storage system 115, and for transmitting the storage objects to destination storage system. The cloud data manager 155 generates the storage objects and transmits them to the destination storage system 115 using the provided APIs.

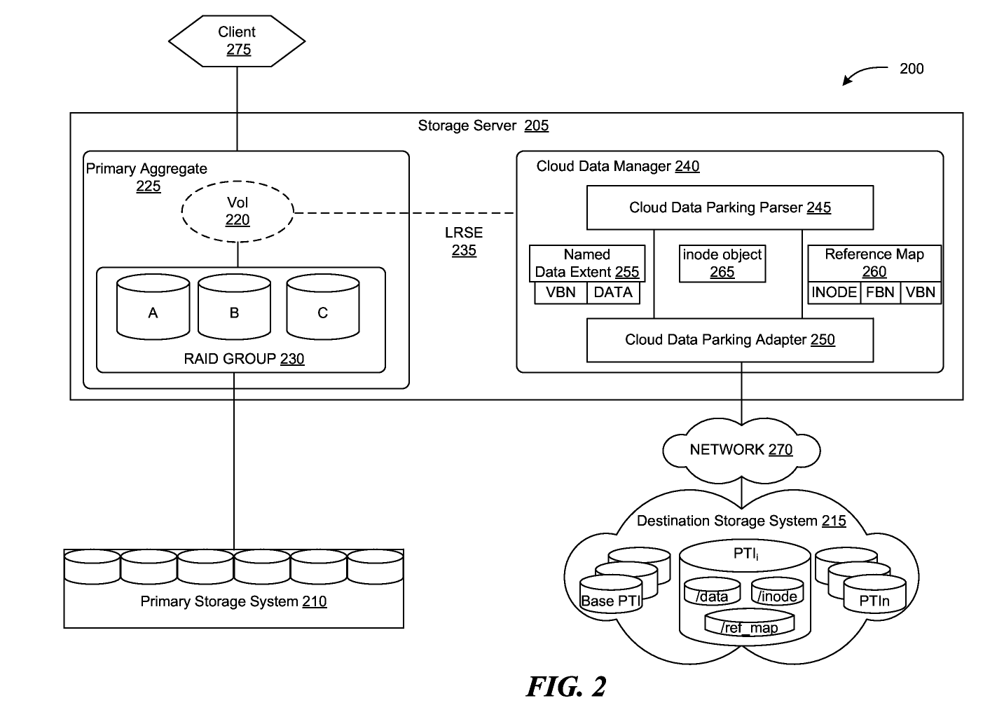

FIG. 2 is a block diagram of a networked storage system 200 for backing up data to and restoring from a cloud storage service, consistent with various embodiments of the disclosed technology. The networked storage system 200 may be implemented in the environment 100 of FIG. 1. The storage server 205 can be similar to the storage server 105, the primary storage system 210 to the primary storage system 110, destination storage system 215 to the destination storage system 115, and the cloud data manager 240 to the cloud data manager 155.

The storage server 205 can be a block-based storage server, e.g., NFS file servers provided by NetApp of Sunnyvale, Calif., that uses various storage operating systems, including the NetApp® Data ONTAP™ storage operating system. The storage server 205 receives data from a client 275 and stores the data, e.g., as blocks, in the primary storage system 210. The storage server 205 is coupled to the primary storage system 210 and to the client 275 through a network. The network may be, for example, a local area network (LAN), a wide area network (WAN), a metropolitan area network (MAN), a wireless network, a global area network (GAN) such as the Internet, a Fibre Channel fabric, or the like, or a combination of any such types of networks. The client 275 can be, for example, a conventional personal computer (PC), server-class computer, workstation, or the like.

The primary storage system 210 can be, for example, conventional magnetic disks, optical disks such as CD-ROM or DVD-based storage, magneto-optical (MO) storage, or any other type of non-volatile storage devices suitable for storing large quantities of data. The storage devices can further be organized as a Redundant Array of Inexpensive Disks/Devices (RAID), whereby the storage server 205 accesses the primary storage system 210 using RAID protocols.

It will be appreciated that some embodiments may be implemented with solid-state memories including flash storage devices constituting storage array (e.g., disks). For example, a storage server (e.g., storage server 205) may be operative with non-volatile, solid-state NAND flash devices which are block-oriented devices having good (random) read performance, i.e., read operations to flash devices are substantially faster than write operations. Data stored on a flash device is accessed (e.g., via read and write operations) in units of pages, which in the present embodiment are 4 kB in size, although other page sizes (e.g., 2 KB) may also be used.

The storage server 205 includes a file system layout that writes the data into the primary storage system 210 as blocks. An example of such a file system layout includes a write anywhere file-system (“WAF”) layout (WAF). The WAF layout is block based (e.g., 4 KB blocks that have no fragments), uses inodes to describe the files stored in primary storage system 210, and includes directories that are simply specially formatted files. The WAF layout uses files to store meta-data that describes the layout of the file system. WAF layout meta-data files include an inode file.

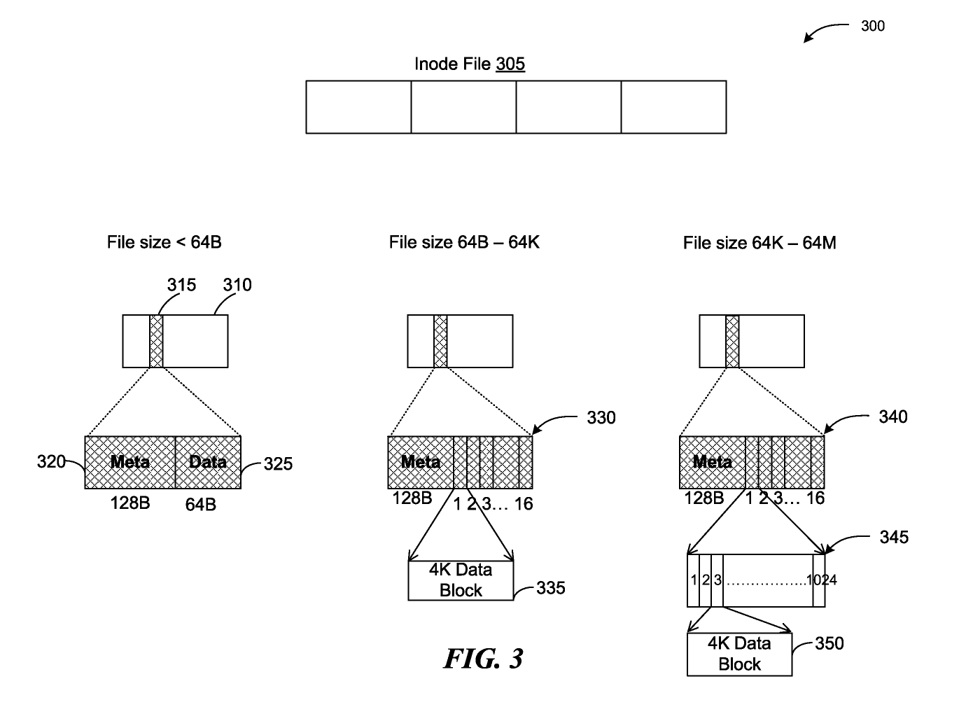

FIG. 3 is a block diagram illustrating various inode configurations, consistent with various embodiments of the disclosed technology. The inode file 305 has the inode table for the file system. Each inode file block of the inode file 305 is of a specified block size, e.g., 4 KB, and includes multiple inodes as illustrated by inode file block 310. The inode 315 includes metadata 320 and a data block 325 of a specified size, e.g., 64 bytes. The inode metadata 320 includes information about the owner of a file the inode represents, permissions, file size, access time, inode ID, etc. For a small file having a size of 64 bytes or less, data is stored directly in the inode 315 itself, e.g., in the data block 325.

For a file having a size that is greater than 64 bytes and less than or equal to 64 KB, a single level of indirection is used to refer to the data blocks. For example, the data block 325 can be used as a block 330 to store the location of the actual data blocks that have the file data. The block 330 has multiple block number entries, e.g., 16 block number entries of 4 bytes each, each of which can have reference to a data block 335 that has the data. The data block 335 can be of a specified size, e.g., 4 KB.

For a file having a size that is greater than 64 KB and is less than 64 MB, two levels of indirection can be used. For example, each of the block number entries of block 340 references a single-indirect data block 345. In turn, each 4 KB single-indirect data block 345 comprises 1024 pointers that reference 4 KB data blocks 350. Similarly, for a file having a size that is greater than 64 MB additional levels of indirection can be used. Accordingly, a file in the primary storage system can be represented using an inode. The inode includes the data of the file or has references to the data extents that have the data of the file. Each of the data blocks within the inode is identified using an inode FBN. Each of the data blocks has a data extent ID that uniquely identifies the data block. Further, the inode has an associated inode ID that uniquely identifies the file.

The data extent also has an associated ID that uniquely identifies the data extent. In some embodiments, the data extent ID is a volume block number (VBN) in a volume 220 of an aggregate 225 of the primary storage system 210. The aggregate 225 is a group of one or more physical storage devices of the primary storage system 210, such as a RAID group 230. The aggregate 225 is logically divided into one or more volumes, e.g., volume 220. The volume 220 is a logical collection of space within an aggregate. The aggregate 225 has its own physical volume block number (PVBN) space and maintains metadata, such as block allocation “bitmap” structures, within that PVBN space. Each volume also has its own VBN space and maintains metadata, such as block allocation bitmap structures, within that VBN space.

When a PTI of the file system of the storage server 205 is generated, the inodes of the files in the primary storage system 210 and the data extents having the data of the files are copied to the PTI. The PTI can then be replicated to the destination storage system 215. As described with reference to FIG. 1, a replication stream is generated, e.g., by a replication module 150, to replicate the PTI to the destination storage system 215. In some embodiments, the replication stream is generated using a logical replication engine with storage efficiency (LRSE) protocol 235.

The LRSE protocol 235 is intended for use as a protocol to replicate data between two hosts while preserving storage efficiency. The LRSE protocol 235 allows preserving storage efficiency over the wire, e.g., during transmission, as well as on the storage devices at the destination storage by naming the replicated data. The LRSE protocol 235 allows the sender, e.g., primary storage system 210, to send the named data once and refer to it (by name) multiple times in the future. In LRSE protocol 235, the sender, e.g., primary storage system 210 identifies and sends new/changed data extents along with their names (without a file context). The sender also identifies new/changed files and describes the changed contents in the files using the names.

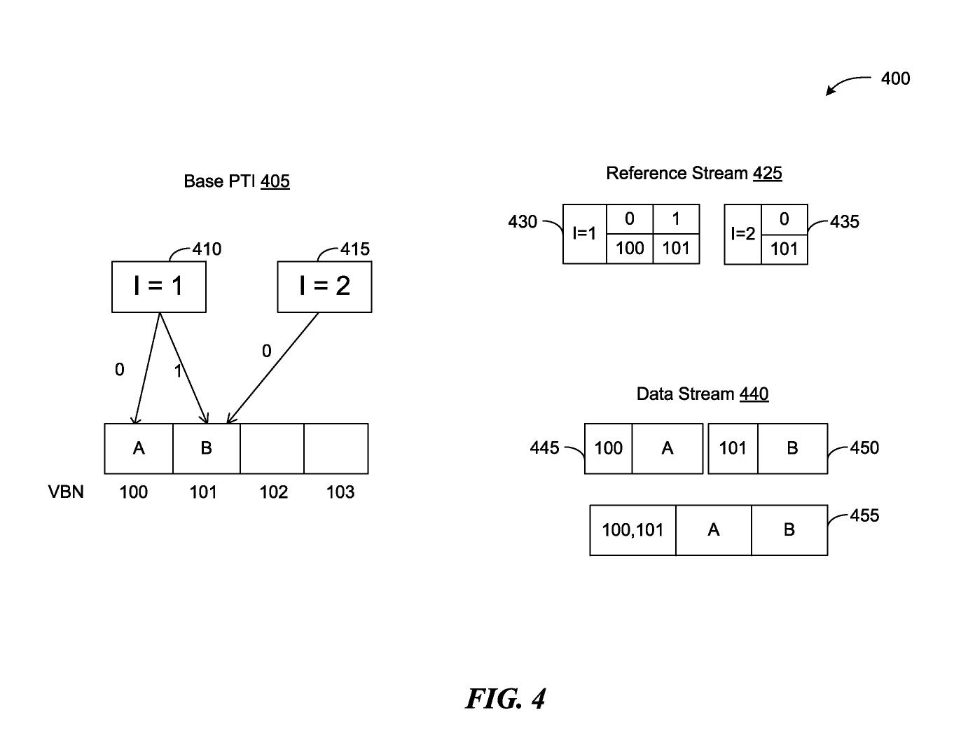

FIG. 4 is a block diagram 400 illustrating a replication stream generated using LRSE protocol, consistent with various embodiments of the disclosed technology. For example, consider that a base PTI 405 of the primary storage system 210 of FIG. 2, includes two files, a first file having data “A” and “B” and a second file having only “B.” The data “A” and “B” are stored in two data extents, data extent ID “100” and data extent ID “101.”

In the block diagram 400, the first file is represented using inode 410. The inode 410 includes the data extents, e.g., data extent ID “100” and data extent ID “101” that have the data of the first file as FBN “0” and FBN “1” of the inode, respectively. The FBN identifies the data extents within the inode. Similarly, the second file is represented using inode 415 and the data extent, e.g., data extent ID “101,” that has the data of the second file is included as FBN “0” of the inode 415. In some embodiments, the storage server 205 stores the data in a de-duplicated format. That is, the files having a portion of data that is identical between the files share the data extent having the identical data. Accordingly, the inode 415 shares the data extent “101” with inode 410. In some embodiments, the identical data can be stored in different data extents, e.g., different data extents for each of the files. In some embodiments, the data extent ID can be a VBN of the volume 220 at the primary storage system 210.

The replication stream for the above base PTI 405 can include a reference stream 425 having reference maps 430 and 435, a data stream having named data extents 445 and 450. The reference map 430 of the inode 410 includes a mapping of FBNs of the inode 410 to data extent IDs, e.g., “100” and “101,” of the data extents that have the data of the file which the inode 410 represents. Similarly, the reference map 435 includes a mapping of FBNs of the inode 415 to data extent ID, e.g., “101” of the data extent that has the data for the file which the inode 415 represents.

The replication stream can also include a data stream 440 having data extents having the data of the files represented by inodes 410 and 415. The data stream 440 includes the data extents and their corresponding IDs (“names”), and hence referred to as “named data extents.” In some embodiments, the named data extents 445 and 450 may be generated separately, e.g., one named data extent for every data extent. In some embodiments, the named data extents 445 and 450 may be generated as a combined named data extent 455. The replication stream can also include metadata of inodes 410 and 415 (not illustrated).

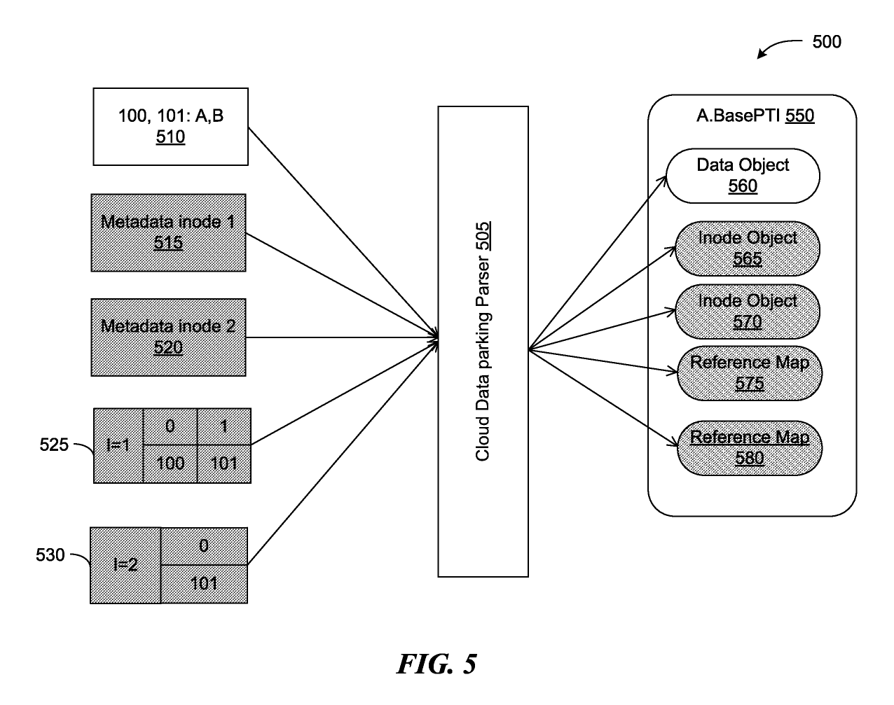

The replication stream can be transmitted to the destination storage system 215 to store the base PTI 405. However, the contents of the replication stream may have to be converted or translated or mapped to storage objects, which is the format of data expected by the destination storage system 215. The replication stream is sent to a cloud data manager 240 for converting the contents of the replication stream to the storage objects and transmitting them to destination storage system 215. A cloud data parking parser 245 in the cloud data manager 240 parses the replication stream to identify the reference maps 430 and 435, named data extent 455, and the metadata of inodes 410 and 415. After identifying the contents, the cloud data parking parser 245 generates one or more storage objects for the contents of the replication, as illustrated in FIG. 5.

FIG. 5 illustrates a block diagram 500 for creating storage objects from a replication stream, consistent with various embodiments of the disclosed technology. The cloud data parking parser 505 is similar to the cloud data parking parser 245 of FIG. 2, the named data extents 510 is similar to named data extent 455 of FIG. 4, and the reference maps 525 and 530 to the reference maps 430 and 435, respectively. The contents of the replication stream can arrive in any order, that is, the reference maps 525 and 530, name data extents 510, and the metadata 515 and 520 of inodes 410 and 415, respectively, can arrive at the cloud data parking parser 505 in any order. The cloud data parking parser 505 understands the LRSE protocol 235 and therefore, identifies the contents of the replication stream regardless of the order they arrive in.

The cloud data parking parser 505 creates storage objects of various types representing the content of the replication stream. For example, the cloud data parking parser 505 can create a data storage object 255 corresponding to data extents, a reference map storage object 260 corresponding to a reference map, and an inode storage object 265 corresponding to the metadata of inode. In FIG. 5, the cloud data parking parser 505 creates a data storage object 560 corresponding to the named data extents 510. The data storage object 560 includes the data extents and their corresponding data extent IDs. In some embodiments, more than one data storage object can be generated for the named data extents 510, e.g., one data storage object per data extent.

The cloud data parking parser 505 creates reference map storage objects 575 and 580 corresponding to the reference maps 525 and 530. The cloud data parking parser 505 also creates inode storage objects 565 and 570 corresponding to the metadata 515 and 520 of the inodes 410 and 415. The inode storage object can include metadata of an inode, e.g., created by, date and time, modified date and time, owner, number of file blocks in an inode (e.g., size of the file to which the inode corresponds) etc. The storage objects may be stored in an object container 550 at the destination storage system 215.

Referring back to FIG. 2, after the various storage objects are created, the cloud data parking adapter 250 transmits the above storage objects to the destination storage system 215 over a communication network 270. In some embodiments, the storage objects are transmitted over the communication network 270 using hyper-text transfer protocol (HTTP). The cloud data parking adapter 250 can use the APIs of the destination storage system 215 to transmit the storage objects. Accordingly, the base PTI 405 is backed up to the destination storage system 215.

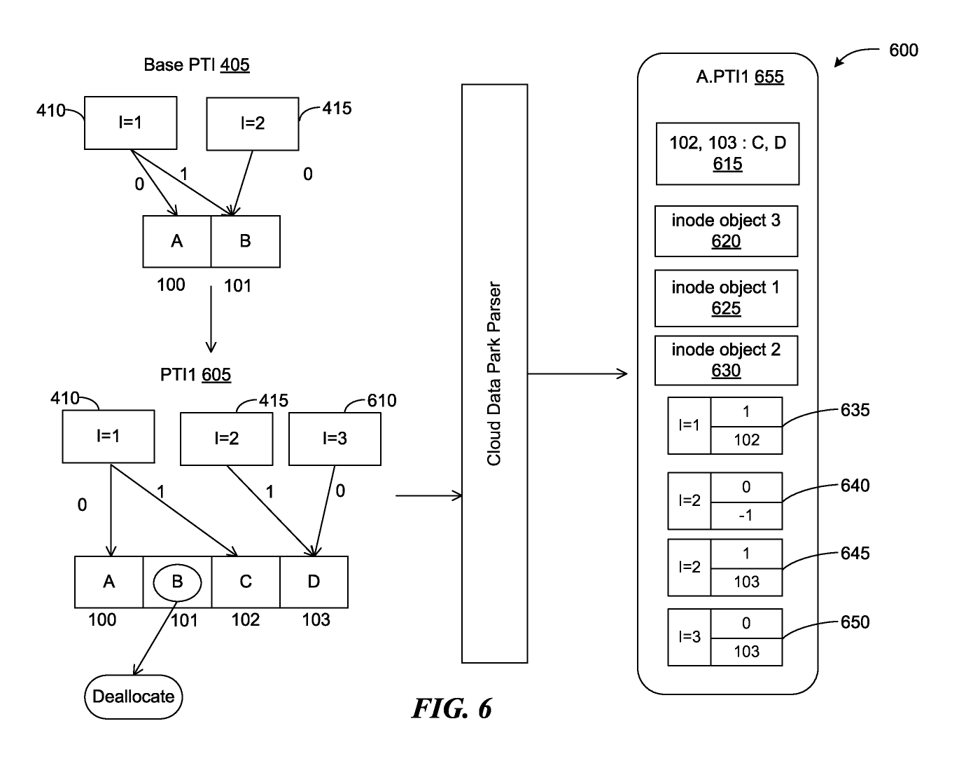

FIG. 6 is a block diagram 600 illustrating backing up incremental PTIs to a destination storage system, consistent with various embodiments of the disclosed technology. In some embodiments, PTIs may be generated at a host system incrementally, e.g., a second PTI may be generated some period after the base PTI is generated. Such incremental PTIs can be backed up to the destination storage system by backing up only a difference between the second PTI and the base PTI to the destination storage system. The difference can include the changes made to the primary storage system, e.g., addition, deletion or modification of files, after the base PTI was generated. This way, the entire data need not be transmitted again for backing up the incremental PTI, which results in a significant reduction in consumption of the resources, e.g., network bandwidth, for backing up the PTI.

In some embodiments, the incremental PTIs can be backed up using the system 200 of FIG. 2. Consider that a base PTI, e.g., base PTI 405 of FIG. 4, of the primary storage system 210 is backed up to the destination storage system 215. A PTI “SS1” 605 is generated at the primary storage system 210 some period after the base PTI 405 is generated. In the PTI 605, the inode 410 includes data extents “100” and “101,” and the inode 410 includes data extent “103.” Further, a new inode 610, which corresponds to a new file created after the base PTI 405 is generated, includes data extent “103.” On comparing the PTI 605 with the base PTI 405 that was previously backed up, the changes can be identified as follows: (a) the FBN “1” of inode 410 is updated to include a new data extent “102,” (b) the FBN “1” of inode 415 is updated to include a new data extent “103,” (c) a new inode 610 is created and its FBN “0” includes data extent “103,” and (d) the data in data extent “101” is not used anymore. In some embodiments, the storage server 205 can use a specific application to determine a difference between two PTIs.

The replication stream transmits the differences to the cloud data parking parser 245. The cloud data parking parser 245 generates the following storage objects: (a) data storage object 615 corresponding data extents “102” and “103,” (b) an inode storage object 620 corresponding to inode 610, (c) inode storage objects 625 and 630 corresponding to inodes 410 and 415 because the metadata of these inodes, e.g., access time, has changed, (d) a reference map object 635 mapping FBN “1” of inode 410 to data extent ID “102,” (e) a reference map object 640 mapping a FBN “0” of inode 415 to “−1”, indicating that data in data extent “102” is to be deallocated, (f) a reference map object 645 mapping FBN “1” of inode 410 to data extent ID “103,” (g) and a reference map object 650 mapping FBN “0” of inode 610 to data extent ID “103.” These storage objects are then transmitted to the destination storage system 215, where they are stored in an object container corresponding to the PTI 605, e.g., object container 655.

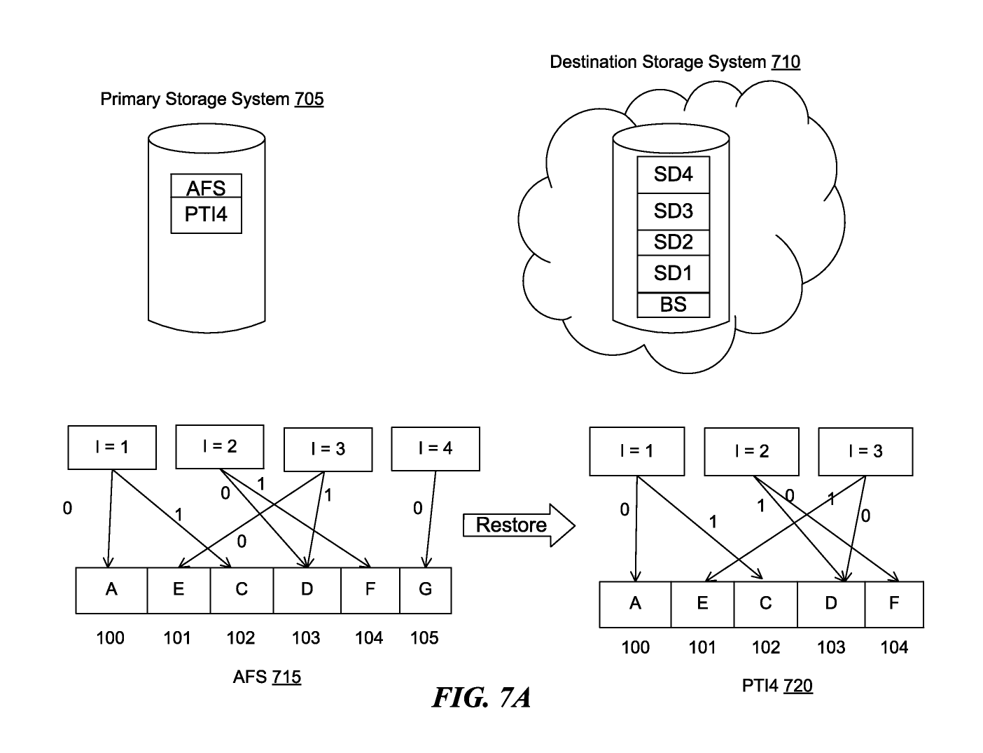

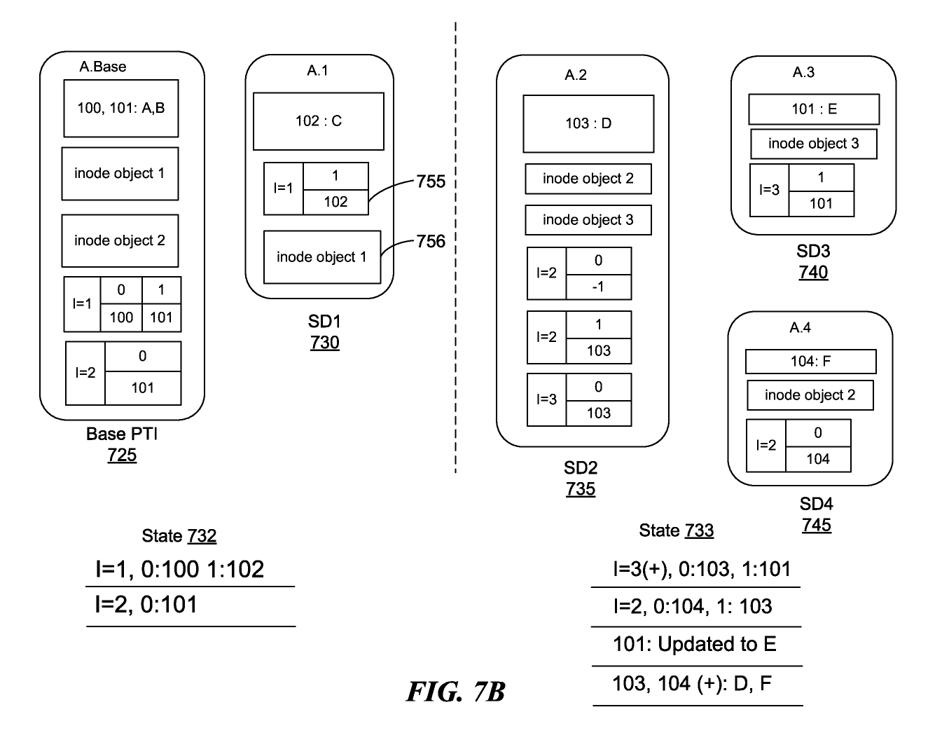

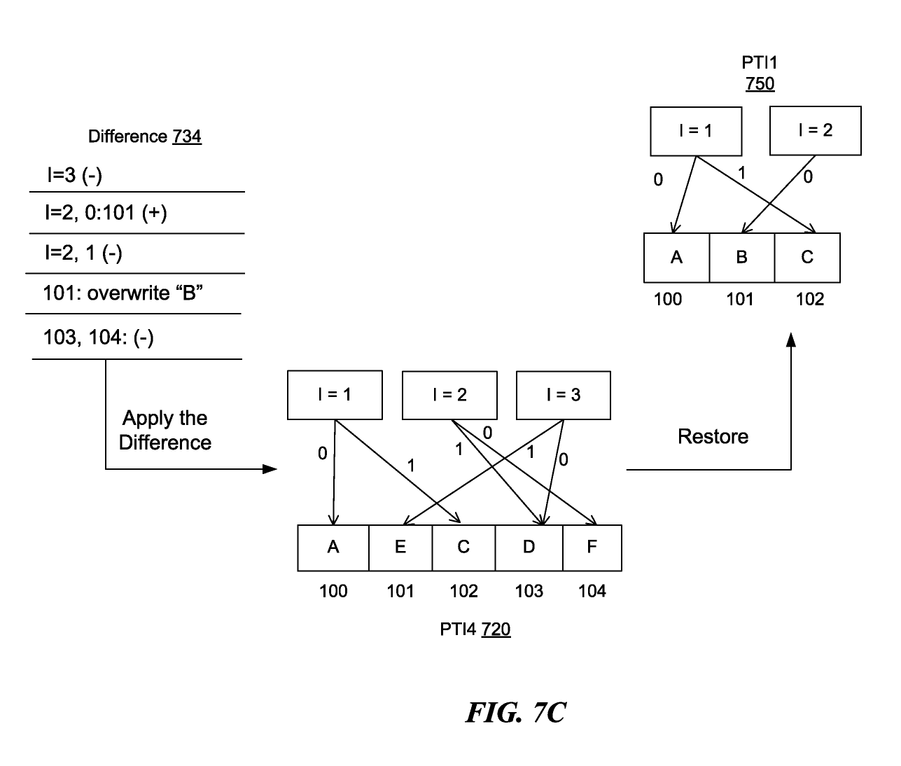

FIG. 7, which includes FIGS. 7A, 7B and 7C, is a block diagram 700 illustrating recovering data from a destination storage system to restore a primary storage system to a particular PTI, consistent with various embodiments of the disclosed technology. In some embodiments, the recovering of data can be implemented in the system 200 of FIG. 2. The primary storage system 705 can be similar to the primary storage system 210 and the destination storage system 710 to the destination storage system 215. In some embodiments, while multiple PTIs of the primary storage system 705 are backed up to and maintained at the destination storage system 710, e.g., as incremental PTIs (also referred to as “PTI difference” (SD)), not all the PTIs may be maintained at the primary storage system 705. Some or all of the PTIs may be deleted from the primary storage system 705 after they are backed up to the destination storage system 710.

In the example of FIG. 7, the destination storage system 710 includes incremental PTIs of the primary storage system 705, e.g., a base PTI 725, a first SD 730, a second SD 735, a third SD 740, and a fourth SD 745. The primary storage system 705 may have only fourth PTI 720. In some embodiments, while a PTI at the primary storage system 705 has a complete copy of the file system of the primary storage system, each of the incremental PTIs maintained at the destination storage system 710 may include a difference, e.g., data corresponding to the difference, between the corresponding incremental PTI and a previous incremental PTI. For example, the fourth SD 745 includes the difference between the data on the primary storage system 705 at the time fourth PTI 720 is generated on the primary storage system 705 and the data corresponding to the third SD 740 on the destination storage system 710.

The AFS, which is a current state of the primary storage system 705, is as illustrated in AFS 715. The AFS 715 indicates the primary storage system 705 has four files, which are represented by corresponding inodes, e.g., inode “1,” inode “2,” inode “3,” and inode “4.” In some embodiments, the numbers “1”-“4” associated with the inodes are inode IDs. The inode “1” includes two data extents “100” and “103,” that is, the data of file represented by inode “1” is contained in the data extents “100” and “103.” Similarly, the inode “2” includes data extents “103” and “104,” the inode “3” includes data extents “101” and “103,” and the inode “4” includes data extent “105.”

In some embodiments, to restore the primary storage system 705 to a particular PTI, the primary storage system 705 may be first restored to a PTI that is common between the primary storage system 705 and the destination storage system 710. After restoring to the common PTI, a difference between the common PTI and the particular PTI is obtained from the destination storage system 710. The difference is applied to the common PTI at the primary storage system 705 which then restores the primary storage system 705 to the particular PTI.

In some embodiments, obtaining the difference includes identifying a state of the primary storage system 705 at the particular PTI. The state can be identified by traversing all the PTIs from the base PTI to the particular PTI and determining the inodes and their data extents stored at the primary storage system 705 at the time the particular PTI is generated. Then, the state of the primary storage system 705 at the common PTI is determined by traversing all the SDs starting from a SD following the particular PTI to the common PTI in the destination storage system 710. The change in state or the difference is determined as (a) inodes that are added to and/or deleted from the primary storage system 705 after a PTI corresponding to the first SD 730 is generated (a) data extents that are added to and/or deleted from the primary storage system 705 after the PTI corresponding to the first SD 730 is generated, and (c) changes made to the reference maps of the inodes.

After the difference is computed, replicating jobs are generated to apply the difference to the common PTI on the primary storage system 705, thereby restoring the primary storage system to the particular PTI. The replicator jobs can perform one or more of: (a) deleting inodes and/or data extents that are added to the primary storage system 705 after a PTI corresponding to the first SD 730 is generated, (b) adding inodes and/or data extents that are deleted from the primary storage system 705 after a PTI corresponding to the first SD 730 is generated, which can require fetching data corresponding to the added data extents from the destination storage system 710, and (c) reverting the changes made to the reference maps of the inodes after a PTI corresponding to the first SD 730 is generated.

In some embodiments, by restoring the primary storage system 705 to the common PTI before restoring to the particular PTI, the amount of data that has to be obtained from the destination storage system 710 is minimized. This can result in reduced consumption of resources, e.g., network bandwidth, time etc.

The following paragraphs describe restoring the primary storage system 705 to the first SD 730. The primary storage system 705 is restored from the AFS 715 to the common PTI, e.g., fourth PTI 720 which corresponds to the fourth SD 745. Restoring to the common PTI includes identifying the difference in data between the AFS 715 and the fourth PTI 720. The difference between the two PTIs is that the AFS 715 has a new inode “4” and data extent “105” of inode “4” that are not present in fourth PTI 720. Accordingly, the inode “4” and its data extent “105” are deleted from the AFS 715 to restore the primary storage system 705 to the fourth PTI 720.

The state 732 of the primary storage system 705 at the first SD 730 is determined by traversing all the SDs from the base PTI 725 to the first SD 730 and identifying the inodes and their data extents stored at the time the first SD 730 is generated. The state 732 includes two inodes, “inode 1” and “inode 2”, wherein “inode 1” includes data extents “100” and “102” and “inode 2” includes data extent “101.”

A state 733 of the primary storage system 705 at the fourth SD 745 is determined by traversing all the SDs from the second SD 735 to the fourth SD 745 and identifying (a) a set of inodes and/or data extents added to and/or deleted from the primary storage system 705 after the first SD 730 is generated, and (b) reference maps of the inodes that have changed. The state 733 indicates that (a) inode “3” is added, (b) reference map of inode “2” has changed, e.g., mapping of FBN “0” of inode “2” has changed from data extent “101” to “104” (e.g., due to change in data content of file to which inode “2” corresponds), and (c) inode “2” has a new block, FBN “1,” mapped to data extent “103.”

After the state 733 at the fourth SD 745 is determined, the difference 734 between the state 732 and the state 733 is computed and a replication job is generated to apply the difference 734 to the primary storage system 705. The replication job, when executed, at the primary storage system 705, applies the difference 734 to the fourth PTI 720 by deleting the inode “3,” changing the reference map of inode “2”—e.g., change mapping of FBN “0” of inode “2” to data extent “101,” updating the data extent “101” to include data “B,” and removing the mapping of FBN “1” of inode “2” from data extent “103.” Also, because none of the inodes refer to data in data extents “103” and “104”, the data in those blocks is deleted. Thus, the primary storage system 705 is restored to the first PTI 750.

In some embodiments, the primary storage system 705 can also recover a file or a group of files from a particular PTI at the destination storage system 710. To restore a file to a version of particular PTI, a cloud data manager, e.g., the cloud data manager 240 of FIG. 2 traverses the PTIs at the destination storage system 710 in a reverse chronological order starting from the particular PTI to a PTI from which the data of the file corresponding to the particular PTI can be retrieved. After the data is retrieved, the data (and the reference map containing the mapping of the FBNs of the inode to the data) is transmitted to the primary storage system 705 for restoring the file. For example, consider that the primary storage system 705 intends to restore the file corresponding to inode “1” to a version of the second SD 735. The cloud data manager 240 analyzes the second SD 735 to determine if it contains any data for inode “1.” Since the second SD 745 does not contain inode “1” data, the cloud data manager 240 proceeds to analyze an earlier or a previous PTI, e.g., first SD 730. At the first SD 730, the cloud data manager 240 determines from the metadata of the inode “1” in inode object 756 that a file block, FBN “1” of the inode “1” is updated with new data, and obtains the new data “C” from the data extent “102” using the reference map 755.

Further, the cloud data manager 240 also determines from the metadata that the inode “1” contains two file blocks. So the cloud data manager 240 continues to traverse earlier PTIs one by one until it finds a PTI that has information regarding the remaining data of inode “1.” Consequently, the cloud data manager 240 arrives at the base PTI 725 from where it obtains the data “A” of FBN “0” stored at data extent “100.” After obtaining the data of the entire file, the cloud data manager 240 sends the data of the file corresponding to the inode “1” and the reference map mapping the data extents containing the data of the file to the file blocks of the inode to the primary storage system 705. In some embodiments, the cloud data manager 240 can transmit the data and the reference maps to the primary storage system 705 using a replication module, e.g., replication module 150 of FIG. 1. The replication module 150 can obtain the file from the destination storage system 710, and restore the file at the primary storage system 705 using the PTI manager 145.

In some embodiments, the PTIs stored at the destination storage system 710 can also be restored to a storage system other than the storage system (e.g., primary storage system 705) from which the data is backed up to the destination storage system 710.

In some embodiments, one or more of the PTIs at the destination storage system 710 can be compacted. In some embodiments, when multiple PTIs are backed up to the destination storage system 710, after a period, some of the PTIs may not be accessed as often as the others, that is, some of the PTIs become cold PTIs. It may be economical to archive the cold PTIs to storage systems that is more optimized, e.g., have a lesser $/GB cost, compared to the destination storage system 710. Compaction of a set of PTIs can include archiving the set of PTIs from the destination storage system 710 to another storage system and merging the set of PTIs into a single PTI. The set of PTIs can be merged into one PTI based on various known techniques. In some embodiments, the compaction process can be performed by the cloud data manager 240.

The following describes an example of a compaction process. Consider that the destination storage system 710 has the following PTIs:
Base PTI {I1, I1 {0:100,1:101}, (100,101)}—That is, the base PTI contains the file corresponding to inode “1” which has two file blocks with FBN “0” and “1” having data from extents “100” and “101.”
SD1 {I2,I2{0:100}}—A first incremental PTI where a file corresponding to inode “2” having a file block with FBN “0” containing data from extent “100” is inserted.
SD2 {I3, I2, I3{0:102}, I2{1:100}, (102)}—A second incremental PTI where (a) file corresponding to inode “3” having a file block with FBN “0” containing data from extent “102” is inserted and (b) a file block with FBN “1” having data from extent “100” is inserted into inode “2”.
SD3 {I3, I3{0:104}, (104), I2 removed}—A third incremental PTI where (a) a file block with FBN “0” of inode “3” is updated to have data from extent “104” and (b) a file corresponding to inode “2” is deleted.
SD4 {I3 removed}—A fourth incremental PTI where a file corresponding to inode “3” is deleted.
SD5 {I1, I1 {0:105}, (105)}—A fifth incremental PTI where a file block with FBN “0” of inode “1” is updated to have data from extent “105.”
SD6, and so on until SDn.

So if the cloud data manager 240 compacts the PTIs from base PTI to SD4, the PTIs from base PTI to SD4 are moved to another storage system and the destination storage system 710 is updated to have a compacted view or state of the SD5 as the compacted base PTI.

The compacted view of base PTI to SD4 is as follows:
Compacted View_{Base-SD4}={BS+SD1+SD2+SD3+SD4}={I1, I1{0:100,1:101}, (100,101)}

The Compacted View_{Base-SD4} represents a complete state of the destination storage system 710 at the fourth incremental PTI. Note that the Compacted View_{Base-SD4} does not contain inodes “2” and “3” since they are deleted. In some embodiments, the compaction of a set of PTIs can be a union of all the PTIs in the set of PTIs. However, various other techniques can be used to compact the PTIs in other ways.

After the PTIs, base PTI to SD4, are compacted, the PTI SD5 can be compacted with the Compacted View_{Base->SD4}, to generate a compacted base PTI as follows:
Compacted Base_{SD5}={Base PTI+SD1+SD2+SD3+SD4}+SD5={I1, I1{0:105, 1:101}, (105,101)}

The Compacted Base_{SD5} represents a complete state of the destination storage system 710 at PTI SD5. The destination storage system 710 stores the Compacted Base_{SD5} as the base PTI. To restore a file at the primary storage system 705 to a version corresponding to the fifth incremental PTI SD5 or later PTIs, e.g., SD6 to SDn, the cloud data manager 240 can use the Compacted Base_{SD5} or the later PTIs accordingly. However, to restore a file to a version corresponding to PTIs below SD5, the cloud data manager 240 may have to fetch the PTIs from the archive storage system.

In some embodiments, if the destination storage system 710 did not store the Compacted Base_{SD5}, and instead stored fifth incremental PTI SD5 as it is after the compaction process, then the cloud data manager 240 may have to fetch the earlier PTIs, e.g., base PTI to SD4, from the archive storage system to determine the state of the Compacted Base_{SD5}, e.g., state of inode “1”. Fetching the PTIs from the archive storage system and then determining the state can be resource consuming and therefore, can affect the performance of the storage server 205. Accordingly, storing the compacted view of the fifth incremental PTI SD5 can eliminate the need to fetch the earlier PTIs from the archive storage system to determine the state of the destination storage system 710 at PTI SD5.

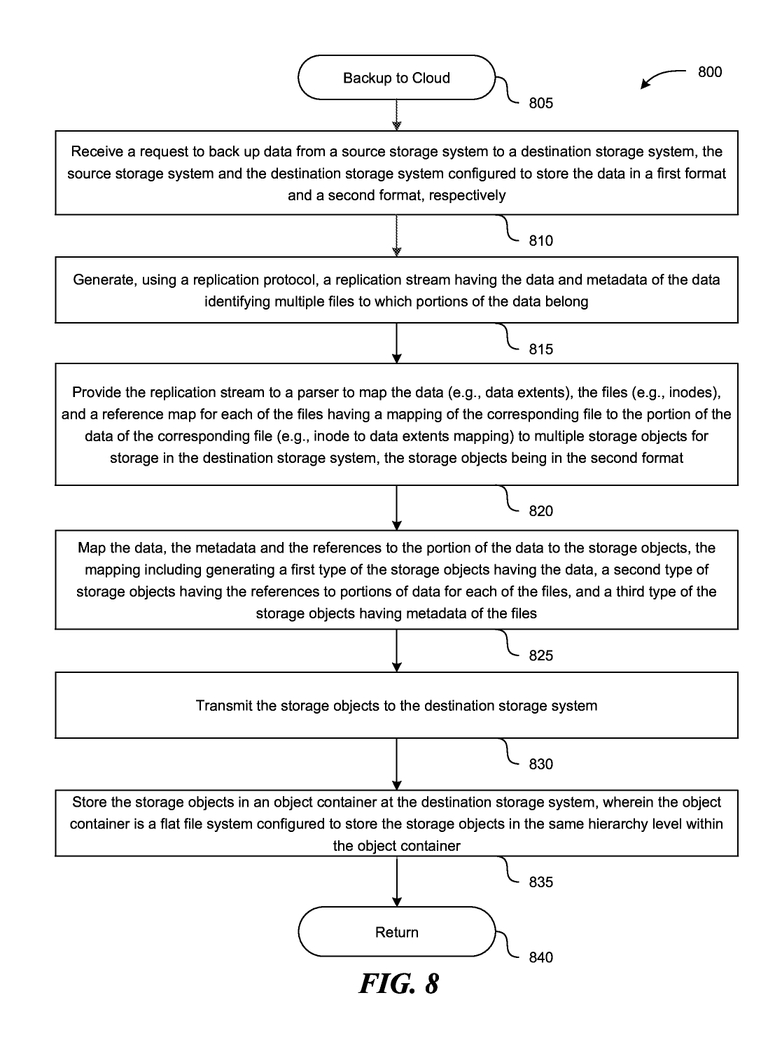

FIG. 8 is a flow diagram a process 800 of backing up data to an object-based destination storage system using LRSE protocol, consistent with various embodiments of the disclosed technology. In some embodiments, the process 800 may be implemented in environment 100 of FIG. 1, and using the system 200 of FIG. 2. The process 800 begins at block 805, and at block 810, the storage server 105 receives a request to back up data from a block-based primary storage system to the object based destination storage system. In some embodiments, the primary storage system manages data in a first format, e.g., as blocks, in which data files are represented using inodes, data extents and reference maps that maps FBNs of inodes to data extents that contain data of the corresponding file. In some embodiments, the file system of the primary storage system can support storing data in a multi-level hierarchy. The destination storage system stores the data in a second format, e.g., as storage objects in a flat file system where an object container stores the storage objects in the same hierarchy. In some embodiments, the destination storage system can be a third party cloud storage service.

At block 815, the replication module 150 associated with the storage server 105 generates a replication stream containing the data to be replicated to the destination storage system from the primary storage system. In some embodiments, the replication module 150 generates the replication stream using a replication protocol, e.g., LRSE protocol. The replication stream can include (a) a first metadata of the data identifying multiple files, e.g., inodes, (b) data, e.g., data extents that contain the data of the files, and (c) a second metadata of the data identifying multiple files to which portions of the data belong, e.g., reference maps that contain a mapping of FBNs of an inode to data extents that contain the data of the file to which the inode corresponds.

At block 820, the replication module 150 sends the replication stream to the cloud data manager 155 to map the data extents, the inodes, and the reference maps to multiple storage objects for storage in the destination storage system. In some embodiments, the cloud data manager 155 can be implemented on the storage server 105. In some embodiments, the cloud data manager 155 can be implemented separate from the storage server 105 and on one or more server computers that can communicate with the storage server 105.

At block 825, the cloud data parking parser 245 parses the replication stream to identify the data extents, the inodes and the reference maps from the stream. The cloud data parking parser 245 can use the LRSE protocol to identify the content of the replication stream. The cloud data parking parser 245 maps the data extents, the inodes and the reference maps to the storage objects. The mapping can include generating a first type of the storage objects containing the data, e.g., data extents, the second type of storage objects containing the reference maps, and a third type of the storage objects containing the metadata of the files, e.g., inodes.

At block 830, the cloud data parking adapter 250 transmits the storage objects to the destination storage system over a communication network. In some embodiments, the storage objects can be transmitted using HTTP. In some embodiments, the cloud data parking adapter 250 uses the APIs of the destination storage system to transmit the storage objects to the destination storage system.

At block 835, the destination storage system 215 receives the storage objects and stores them in an object container. In some embodiments, the storage objects are stored in the same hierarchy level within the object container. In some embodiments, the storage objects can correspond to a PTI of the data at the primary storage system. The destination storage system can have various object containers, each of them corresponding to a particular PTI. The storage objects of the particular PTI can be stored in the object container corresponding to the particular PTI. After storing the storage objects, the process 800 returns at block 840.

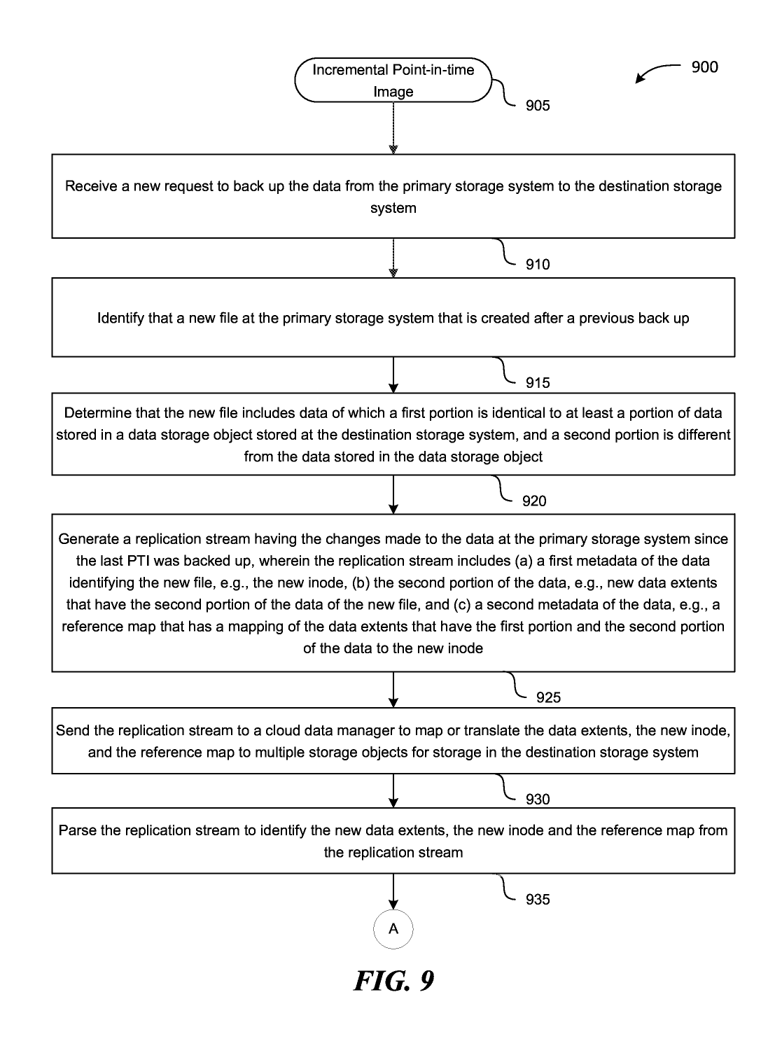

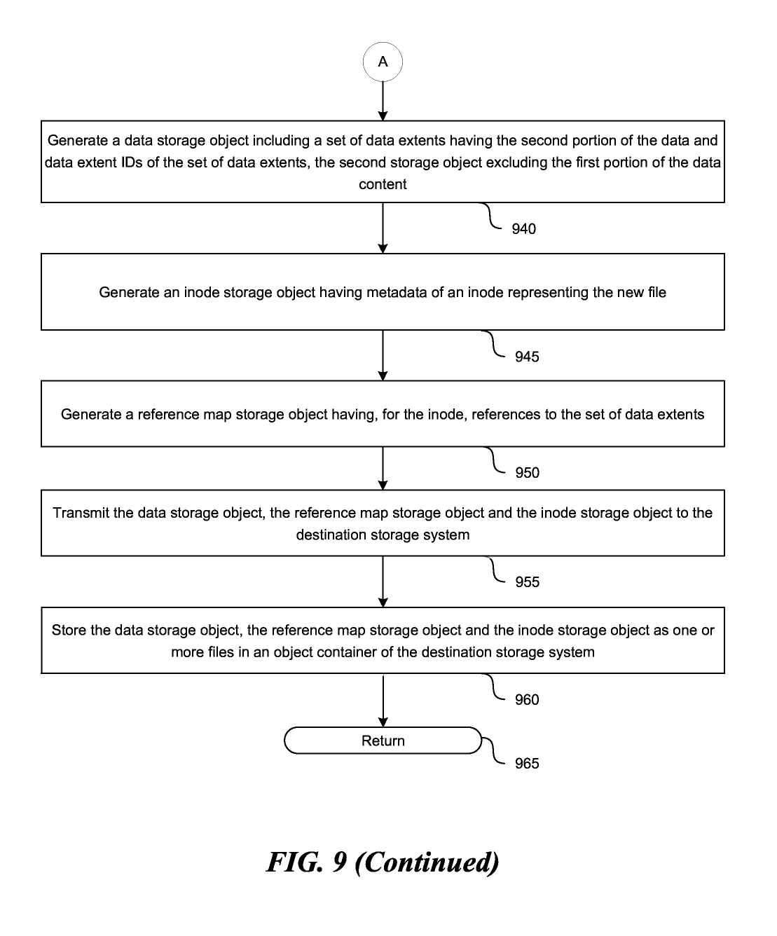

FIG. 9 is a flow diagram of a process 900 for backing up incremental PTIs to an object-based destination storage system using LRSE protocol, consistent with various embodiments of the disclosed technology. In some embodiments, the process 900 may be implemented in environment 100 of FIG. 1, and using the system 200 of FIG. 2. The process 900 backs up multiple PTIs of data from the primary storage system to the destination storage system. The PTIs can be generated sequentially, e.g., at regular intervals. The process 900 begins at block 905, and at block 910, the storage server 105 receives a request to back up a next PTI from the primary storage system to the destination storage system.

At block 915, the PTI manager 145 determines that a new file is created at the primary storage system after a previous PTI is backed up to the destination storage system. The PTI manager 145 identifies the new file. In some embodiments, the PTI manager 145 can be implemented using one or more tools, e.g., SnapDiff, SnapVault of NetApp.

At block 920, the PTI manager 145 determines that the new file includes data of which a first portion is identical to at least a portion of data stored in the storage objects stored at the destination storage system, and a second portion is different from the data stored in the storage objects.

At block 925, the replication module 150 generates a replication stream containing the changes made to the data at the primary storage system because the last PTI was backed up, e.g., second portion of the data. In some embodiments, the replication stream can include (a) a first metadata of the data identifying the new file, e.g., the new inode, (b) the second portion of the data, e.g., new data extents that contain the second portion of the data of the new file, and (c) a second metadata of the data, e.g., a reference map that contains a mapping of the data extents that contain the first portion and the second portion of the data to the FBNs of the new inode. In some embodiments, the replication stream excludes the first portion of the data content that is identical to the data stored in the storage objects at the destination storage system. In some embodiments, the replication stream also excludes any other data at the primary storage system which is previously backed up to the destination storage system.

At block 930, the replication module 150 sends the replication stream to the cloud data manager 155 to map or translate the data extents, the new inode, and the reference map to multiple storage objects of the destination storage system.

At block 935, the cloud data parking parser 245 parses the replication stream to identify the new data extents, the new inode and the reference map from the replication stream. In some embodiments, the cloud data parking parser 245 uses the LRSE protocol to identify the content of the replication stream.

At block 940, the cloud data parking parser 245 generates a data storage object including a set of data extents containing the second portion of the data and data extent IDs of the set of data extents.

At block 945, the cloud data parking parser 245 generates an inode storage object containing the metadata of the new inode.

At block 950, the cloud data parking parser 245 generates a reference-map storage object containing a mapping of the new inode to the set of data extents.

At block 955, the cloud data parking adapter 250 transmits the data storage object, the reference-map storage object, and the inode storage object to the destination storage system.

At block 960, the destination storage system 215 stores the data storage object, the reference map storage object and the inode storage object as one or more files in an object container corresponding to the PTI, and the process 900 returns at block 965.

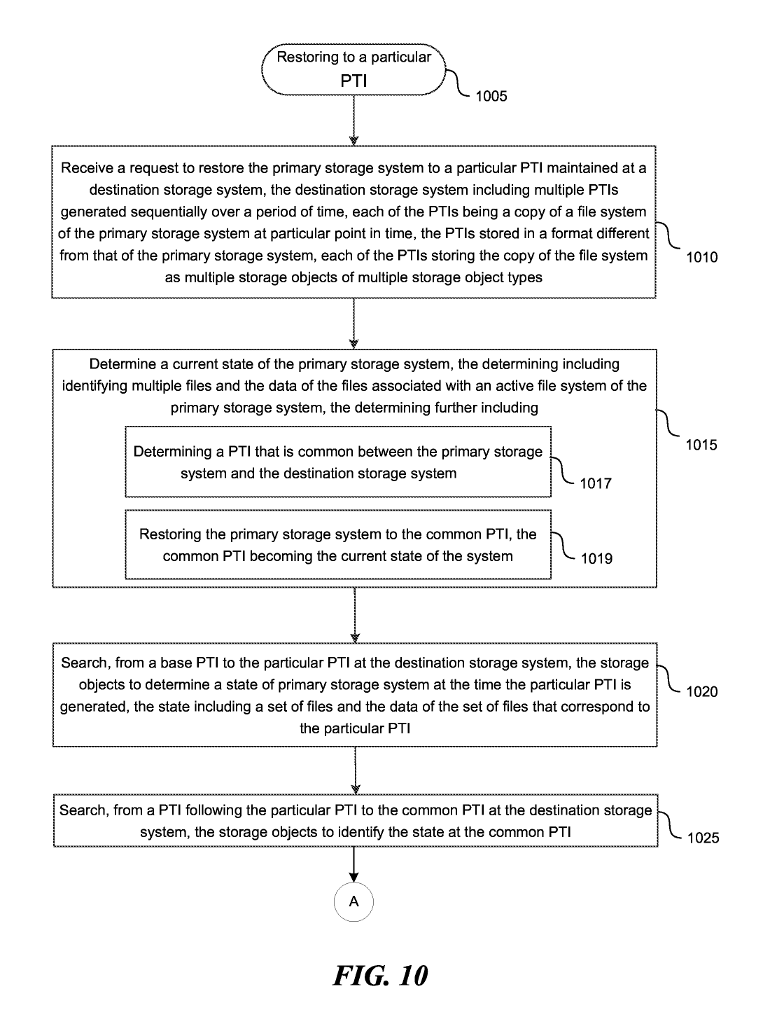

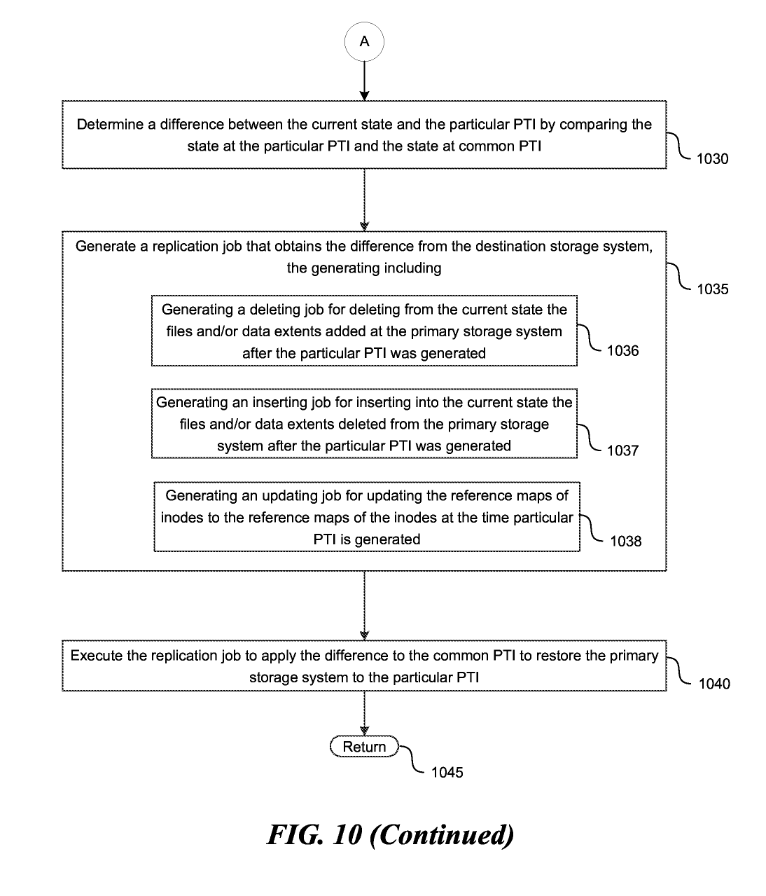

FIG. 10 is a flow diagram of a process 1000 for recovering data from an object-based destination storage system to restore a primary storage system to a particular PTI, consistent with various embodiments of the disclosed technology. In some embodiments, the process 1000 may be implemented in environment 100 of FIG. 1, and using the system 200 of FIG. 2. In some embodiments, the destination storage system contains PTIs, e.g., PTIs of data, backed up from the primary storage system.

The process 1000 begins at block 1005, and at block 1010, the storage server 105 receives a request to restore the primary storage system to a particular PTI maintained at the destination storage system. In some embodiments, the multiple PTIs stored at the destination storage system are copies of PTIs generated at the primary storage system sequentially over a period of time. Each of the PTIs can be a copy of a file system of the primary storage system at the time PTI is generated.

At block 1015, the PTI manager 145 determines a current state of the primary storage system. In some embodiments, determining the current state includes identifying the AFS of the primary storage system, e.g., multiple files and the data of the files stored at the primary storage system currently.

At block 1017, the PTI manager 145 and/or the cloud data manager 155 determines a PTI that is common between the primary storage system and the destination storage system. In some embodiments, while the destination storage system includes copies of all the PTIs generated at the primary storage system, the primary storage system itself may not store all the PTIs. The primary storage system may store some or none of the PTIs.

At block 1019, the PTI manager 145 restores the AFS of the primary storage system to the common PTI. In some embodiments, restoring the AFS to the common PTI includes reverting any changes made to the data and the file system of the primary storage system from the time the common PTI was generated.

At block 1020, the PTI manager 145 and/or the cloud data manager 155 determines a state of the primary storage system, e.g., of a file system of the primary storage system, at the time the particular PTI was generated. In some embodiments, determining the state at the particular PTI includes searching the storage objects from a base PTI to the particular PTI at the destination storage system to identify a set of files, e.g., inodes, and the data of the set of files, e.g., data extents, that correspond to the file system of the primary storage system at the time the particular PTI is generated. In some embodiments, the copies of PTIs stored at the destination storage system can be incremental PTIs (also referred as “PTI difference”). The incremental PTI includes a difference of the data between the corresponding PTI and a previous PTI. One of the PTIs, e.g., a base PTI which is a first of the sequence of PTIs, contains a full copy of the file system of the primary storage system.

At block 1025, the PTI manager 145 and/or the cloud data manager 155 determines a state of the primary storage system at the time the common PTI is generated. In some embodiments, the state at the common PTI is determined by searching the storage objects at the destination storage system from a PTI following the particular PTI to the common PTI to identify the inodes, data extents, and the reference maps of the inodes at the time the common PTI is generated.

At block 1030, the PTI manager 145 and/or the cloud data manager 155 determines a difference between the state at the particular PTI and the state at the common PTI. In some embodiments, determining the difference includes identifying the inodes and/or data extents added and/or deleted and any updates made to the reference maps, e.g., to FBNs of the inodes, because the particular PTI up until the common PTI.

At block 1035, the replication module 150 generates a replication job to obtain the difference from the destination storage system. In some embodiments, generating the replication job includes generating a deleting job for deleting from the current state the inodes and/or data extents that are added at the primary storage system after the particular PTI was generated, as illustrated in block 1036. In some embodiments, generating the replication job also includes generating an inserting job for inserting into the current state the inodes and/or data extents that are deleted from the primary storage system after the particular PTI was generated, as illustrated in block 1037. In some embodiments, generating the replication job also includes generating an updating job to update the reference maps of inodes to the reference maps of the inodes at the time particular PTI is generated, as illustrated in block 1038.

At block 1040, the replication module 150 executes the replication job to apply the difference on the current state of primary storage system to restore the primary storage system to the particular PTI. The process 1000 returns at block 1045.

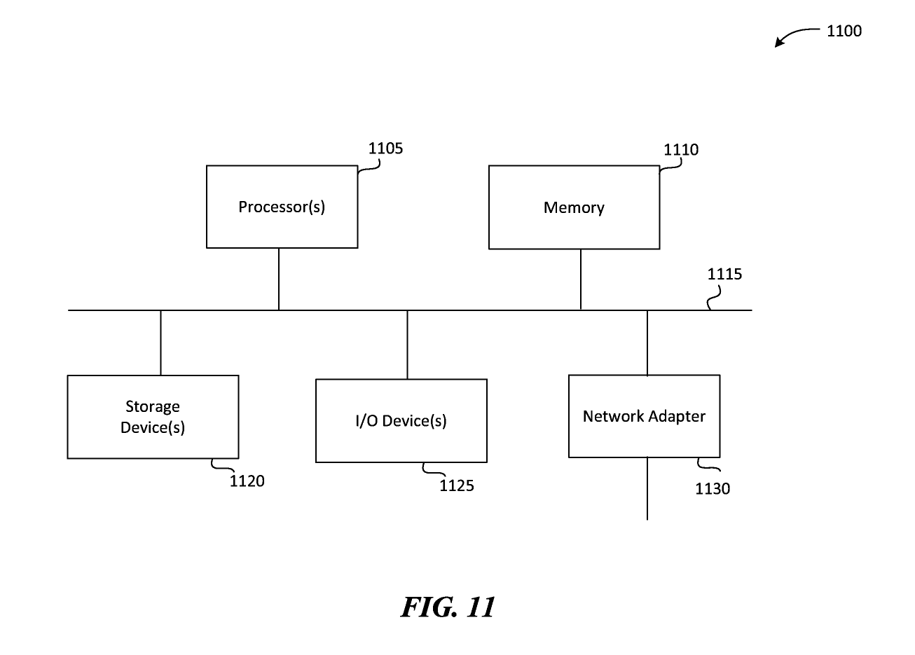

FIG. 11 is a block diagram of a computer system as may be used to implement features of some embodiments of the disclosed technology. The computing system 1100 may be used to implement any of the entities, components or services depicted in the examples of FIGS. 1-10 (and any other components described in this specification). The computing system 1100 may include one or more central processing units (“processors”) 1105, memory 1110, input/output devices 1125 (e.g., keyboard and pointing devices, display devices), storage devices 1120 (e.g., disk drives), and network adapters 1130 (e.g., network interfaces) that are connected to an interconnect 1115. The interconnect 1115 is illustrated as an abstraction that represents any one or more separate physical buses, point to point connections, or both connected by appropriate bridges, adapters, or controllers. The interconnect 1115, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The memory 1110 and storage devices 1120 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 1110 can be implemented as software and/or firmware to program the processor(s) 1105 to carry out actions described above. In some embodiments, such software or firmware may be initially provided to the computing system 1100 by downloading it from a remote system through the computing system 1100 (e.g., via network adapter 1130).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Some terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/we claim:

1. A computer-implemented method, comprising:
receiving, at a primary storage system, a request to back up data from the primary storage system to a destination storage system, the primary storage system and the destination storage system configured to store the data in a first format and a second format, respectively;
generating, using a replication protocol, a replication stream having the data and metadata of the data, the metadata identifying multiple files to which portions of the data belong;
providing the replication stream to a parser to map the data, the files, and a reference map of the files to multiple storage objects for storage in the destination storage system, the reference map including a mapping of a corresponding file to a portion of the data of the corresponding file, the storage objects stored in the second format; and
mapping the data, the metadata and the reference map to the storage objects, the mapping including generating a first type of the storage objects having the data, the second type of storage objects having the references to portions of data for the files, and a third type of the storage objects storing metadata of the files.

2. The computer-implemented method of claim 1 further comprising:
transmitting the storage objects to the destination storage system.

3. The computer-implemented method of claim 2 further comprising:
storing the storage objects in an object container at the destination storage system, the object container being a flat file system configured to store the storage objects in a same hierarchy level within the object container.

4. The computer-implemented method of claim 1, wherein a first portion of data belonging to a first file of the files is stored in a first set of data extents, and a second portion of data belonging to a second file of the files is stored in a second set of data extents, the data extents of the first set and the second set having a common block size and has a data extent identification (ID) that identifies the corresponding data extent.

5. The computer-implemented method of claim 4, wherein the first set of data extents and the second set of data extents include a third data extent that has a portion of data that is identical between the first file and the second file.

6. The computer-implemented method of claim 4, wherein the files is represented as an inode, the inode identified using an inode ID, the inode including references to the data extents that have data of the file to which the inode corresponds.

7. The computer-implemented method of claim 1, wherein generating the replication stream using the replication protocol includes generating:
a data stream for the data, the data stream including multiple data extents in which data corresponding to a first file of the files and a second file of the files is stored at the primary storage system, the data extents having a common block size and having a data extent ID that identifies the corresponding data extent,
a metadata stream for the metadata, the metadata stream including a first inode and a second inode representing the first file and the second file, respectively, and
a reference stream including, for the first inode and the second inode, references to the data extents that have data of the files to which the inodes correspond.

8. The computer-implemented method of claim 7, wherein parsing the replication stream includes parsing the replication stream using the replication protocol to identify the data from the data stream, references to the data extents from the reference stream, and the inodes from the metadata stream.

9. The computer-implemented method of claim 7, wherein mapping the data, references to the portion of the data and the metadata to multiple storage objects includes:
creating a data storage object of the first type, the data storage object including the data extents having the data of the files corresponding to the first inode and the second inode,
creating a first reference map storage object and a second reference map storage object of the second type, the first reference map storage object storing references to a subset of the data extents having data of the first file, the second reference map storage object storing references to a second subset of the data extents having data of the second file, and
creating a first inode storage object and a second inode storage object of the third type, the first inode storage object storing metadata of the first inode and the second inode storage object storing metadata of the second inode.

10. The computer-implemented method of claim 9 further comprising:
receiving, after transmitting the storage objects to the destination storage system, a new request to back up the data from the primary storage system to the destination storage system; and
identifying a new file that is created at the primary storage system after a previous back up, the new file including data of which a first portion is identical to at least a portion of data stored in the data storage object stored at the destination storage system and a second portion is different from the data stored in the data storage object.

11. The computer-implemented method of claim 10 further comprising:
generating a second data storage object of the first type, the second data storage object including a set of data extents having the second portion of the data and data extent IDs of the set of data extents;
generating a third inode storage object of the third type, the third inode storage object having metadata of a third inode representing the new file; and
generating a third reference map storage object of the second type, the third reference map storage object having, for the third inode, references to the set of data extents.

12. The computer-implemented method of claim 11 further comprising:
transmitting the second data storage object, the third reference map storage object and the third inode storage object to the destination storage system.

13. The computer-implemented method of claim 11, wherein the second storage object transmitted to the destination storage excludes the first portion of the data content.

14. A computer-readable storage medium storing instructions that, when executed by a processor, perform the method of:
generating a data image at a primary storage system, the data image having data stored at the primary storage system at a specific time, the data stored in a first format;
providing the data image to a parser to translate the data image into multiple storage objects of a second format for storing at the destination storage system, the providing including:
providing multiple data extents that have the data of multiple files stored at the primary storage system,
providing metadata of the files, the metadata of the files including a unique identification (ID) of the corresponding file,
providing, for the files, a reference map that includes a mapping of the corresponding file to locations of the data extents having the data of the corresponding file; and
parsing the data image to generate the storage objects, the storage objects including:
a data storage object of a first type having the data extents,
for the files, a reference map storage object of a second type having the reference map of the corresponding file, and
for the files, an inode storage object of a third type having metadata of the corresponding file.

15. The computer-readable storage medium of claim 14 further comprising instructions for transmitting the storage objects to the destination storage system.

16. The computer-readable storage medium of claim 15, wherein the second format includes an object-based storage format, the storage objects stored as a specific file in the destination storage system.

17. The computer-readable storage medium of claim 16 further comprising instructions for storing the storage objects in an object container at the destination storage system, the object container configured to store the data as the storage objects, the object container being a flat file system which is configured to store the storage objects in the same hierarchy level within the object container.

18. The computer-readable storage medium of claim 17, wherein the object container corresponds to a particular volume of the primary storage system for which the data image is generated, the particular volume being one of multiple volumes of an aggregate of the primary storage system, the aggregate being a collection of physical storage devices of the primary storage system, the volumes being a logical collection of storage space in the aggregate.

19. The computer-readable storage medium of claim 18, wherein the destination storage system includes multiple object containers, the object containers corresponding to a specific volume of the volumes.

20. The computer-readable storage medium of claim 14, wherein the data image is an image of data in one of multiple volumes of an aggregate of the primary storage system, the aggregate being a collection of physical storage devices of the primary storage system and the volumes being a logical collection of storage space in the aggregate.

21. The computer-readable storage medium of claim 14, wherein the data extents are data blocks of a specific size, and wherein the data extents has a data extent ID.

22. The computer-readable storage medium of claim 21, wherein the data extent ID is volume block number that identifies a particular block of storage space in a volume of an aggregate of the primary storage system for which the data image is generated, the volume block number being a unique identifier within the volume.

23. The computer-readable storage medium of claim 14, wherein providing metadata of the files includes providing an inode that represents the corresponding file, the inode being a metadata container having metadata of the corresponding file, and wherein the unique identification (ID) of the corresponding file is an inode ID of the inode.

24. The computer-readable storage medium of claim 14, wherein in the first format, the files is associated with an inode, the file being managed using the inode, the inode having metadata of the file and a location of a set of blocks that have the data of the file.

25. The computer-readable storage medium of claim 14 further comprising instructions for:
receiving a new request to back up the data from the primary storage system to the destination storage system;
determining a difference between current data of the primary storage system and the data image, the determining including identifying that a new file is created at the primary storage system after a previous back up, the new file including data content of which a first portion is identical to data stored in the data storage object stored at the destination storage system and a second portion is different from the data stored in the data storage object; and
generating a new data image that corresponds to the difference between the current data and the data image.

26. The computer-readable storage medium of claim 25, wherein instructions for generating the new data image includes instructions for:
generating a new data storage object of the first type including the second portion of the data content and a set of data extents having the second portion;
generating a new inode storage object of the third type including metadata of a new inode representing the new file; and
generating a new reference map storage object of the second type including a new reference map having a mapping of an inode ID of the new inode to the locations of the data extents having the second portion of data content.

27. The computer-readable storage medium of claim 25 further comprising instructions for transmitting the new data image to the destination storage system.

28. A computer storage server comprising:
a processor;
a component configured to receive a request to restore a primary storage system to a particular point-in-time image (“PTI”) maintained at a destination storage system, the destination storage system including multiple PTIs of the primary storage system generated sequentially over a period of time, the PTIs being a copy of a file system of the primary storage system at a particular instance, the PTIs stored in a format different from that of the primary storage system, the PTIs storing the copy of the file system as multiple storage objects of multiple storage object types;
a component configured to identify a first state of the primary storage system at the time the particular PTI is generated;
a component configured to identify a second state of the primary storage system at the time a common PTI is generated, the common PTI being a most recent PTI that is available both at the primary storage system and the secondary storage system;
a component configured to determine a difference between the first state and the second state; and
a component configured to generate a replication job that obtains the difference from the destination storage system.

29. The computer storage server of claim 28, wherein the first state of the primary storage system is identified by searching the storage objects at the destination storage system, from a base PTI of the PTIs to the particular PTI, to identify a set of files and the data of the set of files corresponding to the particular PTI.

30. The computer storage server of claim 29, wherein searching the storage objects to identify the first state includes:
searching a first set of inode storage objects to identify the set of files corresponding to the particular PTI, and
for the set of files, searching a first set of reference map storage objects to identify a number of data extents the files has and a set of data extents having the data of the corresponding file.

31. The computer storage server of claim 30, wherein the second state of the primary storage system is identified by searching the storage objects at the destination storage system, from a PTI following the particular PTI to the common PTI, to identify the second state.

32. The computer storage server of claim 31, wherein searching the storage objects to identify the second state includes
searching a second set of inode storage objects to identify a second set of files that are added to, a first subset of the set of files that are deleted from, and a second subset of the set of files which is modified at, the primary storage system after the particular PTI is generated, and
searching, for the second subset of files which is modified, a second set of reference map storage objects to identify a change in the corresponding file, the change including a first set of data extents that has data added to the corresponding file after the particular PTI is generated and a subset of the set of data extents that has data deleted from the corresponding file after the particular PTI is generated.

33. The computer storage server of claim 32, wherein a replication job is generated by:
generating a deleting job for deleting at the primary storage system at least one of a subset of the files that correspond to the second set of files or the first set of data extents having data, and
generating an inserting job for adding at the primary storage system at least one of the first subset of the set of files, a third set of data extents having corresponding data, or the subset of the set of data extents.

34. The computer storage server of claim 33 further comprising:
a component configured to execute the replication job to apply the difference to a current state of the primary storage system to obtain the data corresponding to the particular PTI, the current state being a state of a file system of the primary storage system at the time the request to restore is received.

35. The computer storage server of claim 34, wherein the replication job is configured to:
restore the primary storage system from the current state to the common PTI before executing the replication job, and
execute the replication job to apply the difference to the common PTI of the primary storage system to obtain the data corresponding to the particular PTI.

36. The computer storage server of claim 28, wherein the base PTI includes a full copy of the data stored at the primary storage system at the time the base PTI is generated, and wherein the remaining PTIs includes a difference of the data between the corresponding PTI and a previous PTI.

37. The computer storage server of claim 28 further comprising:
a component configured to perform a compaction process on a set of PTIs in the destination storage system to archive the set of PTIs to a second storage system.

38. The computer storage server of claim 37, wherein the compaction process includes
moving the set of PTIs to the second storage system,
merging a compacted state of the set of PTIs with a succeeding PTI of the PTIs that is generated next in sequence to a latest PTI of the set of PTIs,
generating a compacted state of the succeeding PTI based on the merging, and
storing the compacted state of the succeeding PTI as a new base PTI at the destination storage system.

39. A computer storage server comprising:
a set of storage devices configured to store a data file in a first format, the data file associated with an inode, the inode including the metadata of the data file and locations of multiple data extents having content of the data file;
a replication module configured to generate a replication stream to store a copy of the data file at a destination storage system, the destination storage system configured to store the data file in a second format, the replication stream including the data extents, the inode of the data file and a reference map including a mapping of file block numbers of the inode to locations of the data extents;
a parsing component configured to generate multiple storage objects for storing the data file in destination storage system, the storage objects being of the second format, the storage objects including
a data storage object having the data extents,
a reference map storage object having the reference map, and
an inode storage object having metadata of the inode; and
a network adapter to transmit the storage objects to the destination storage system.

40. The computer storage server of claim 39, wherein the destination storage system is a cloud storage service that is a managed by an entity different from that of the set of storage devices.

41. The computer storage server of claim 39, wherein the destination storage system is a cloud storage service that is a managed by an entity different from that of the computer storage server.

42. A computer storage server comprising:
a processor;
a component configured to receive a request to restore a file at a primary storage system to a version of the file at a particular point-in-time image (“PTI”) maintained at a destination storage system, the destination storage system including multiple PTIs of the primary storage system generated sequentially over a period of time, the PTIs being a copy of a file system of the primary storage system at a particular instance, the PTIs storing the copy of the file system as multiple storage objects of multiple storage object types;
a component configured to analyze the particular PTI to obtain content of the file in the version of the file at the particular PTI, the analyzing including
determining if the particular PTI has contents of the file,
if the particular PTI has the content of the file, obtaining the content of the file from the particular PTI,
if the particular PTI does not have the content of the file or has a portion of the content of the file, analyzing the PTIs generated prior to the particular PTI to obtain the content of the file;
a component configured to generate a replication job to transmit the content of the file to the primary storage system; and
a component configured to restore the file at the particular primary storage system to the version of the file at the particular PTI.
